(19) United States
(12) Patent Application Publication
(10) Pub. No.: US 2019/0081540 A1
(43) Pub. Date: Mar. 14, 2019

(54) ELECTRIC CONDUCTOR INSERTION DEVICE AND INSERTION METHOD

(71) Applicant: HONDA MOTOR CO., LTD., Tokyo (JP)

(72) Inventors: Keiichiro Oka, Hagagun, Tochigi (JP); Yutaka Matsumoto, Hagagun, Tochigi (JP)

(21) Appl. No.: 16/084,835

(22) PCT Filed: Mar. 17, 2017
(86) PCT No.: PCT/JP2017/011027

§ 371 Date: Sep. 13, 2018

(30) Foreign Application Priority Data
Mar. 18, 2016 (JP) 2016-055909

(51) Int. Cl. H02K 15/085; H02K 1/16; H02K 3/12

(52) U.S. Cl. CPC H02K 15/085; H02K 3/12; H02K 1/16

(57) ABSTRACT

An electric conductor insertion device and insertion method with which the impact of variations in axial direction length of a stator core can be suppressed. An insertion device includes: a guide part that guides a leg part into a slot; a pair of expanding plates that extend in an insertion direction and are capable of expanding at the distal end side; a relative movement part that relatively moves the guide part or a stator core in the axial direction so that distal ends of the expanding plates are disposed on the inside of a protruding part of the insulation paper; a pressing part that presses a top surface of the stator core downwards in the axial direction; and an insertion movement part that inserts the leg part and presses the leg part in the insertion direction to insert the leg part into the slot.

### TECHNICAL FIELD

The present invention relates to an electric conductor insertion device and an electric conductor insertion method using the insertion device.

### BACKGROUND ART

Conventionally, a stator coil for a rotary electric machine is formed by the leg parts of substantially U-shaped electric conductors being respectively inserted into slots of a stator core from a central axis direction and then the end parts of the leg parts being interconnected. An insulation paper is inserted in each of the substantially rectangular slots and along the inner surface of the slot (to cover all sides thereof). Contact between the electric conductor and the stator core is avoided by the insulation paper.

In most cases, the insulation paper is inserted into the slot with the gap between the insulation papers exceeding the width of (the leg part of) the electric conductor so that the electric conductor can be inserted. However, a problem or the like that arises during insulation paper insertion may cause the gap between the insulation papers to become narrow. In this case, the leg part of the electric conductor abuts against the insulation paper and pushes the insulation paper from above, and then the insulation paper may be deformed and it may be impossible to push the electric conductor to a regular position.

Proposed in this regard is an electric conductor insertion device that has a pair of expanding plates extending in an insertion direction, capable of expanding at the distal end side, extending obliquely with respect to the insertion direction so as to become close to each other toward the distal end side, and formed such that the gap therebetween is narrower than the width of the insulation paper on the distal end side and wider than the width of the leg part of the electric conductor on the proximal end side (see, for example, Patent Document 1).

Patent Document 1: Japanese Patent No. 5841017

### DISCLOSURE OF THE INVENTION

### Problems to be Solved by the Invention

In the insertion device that is disclosed in Patent Document 1, the distal ends of the expanding plates are arranged inside the part of the insulation paper that protrudes from the top surface of the stator core not to regulate an axial movement of the stator core by expanding in the slot during electric conductor insertion. However, the stator core is formed by thin steel plates being stacked, and thus each stator core may undergo variations in axial direction length (height). Even if the accuracy of the movement position of the expanding plate in the axial direction is improved, the variations in axial direction length (height) of the stator core is unpredictable, and thus the expanding plate may regulate an axial movement of the stator core during electric conductor insertion by expanding in the slot.

The present invention has been made in view of the above problems, and an object thereof is to provide an electric conductor insertion device and insertion method with which the impact of variations in axial direction length of a stator core can be suppressed.

### Means for Solving the Problems

In order to achieve the above object, the present invention provides an electric conductor insertion device (such as an insertion device 1 to be described later) which inserts an electric conductor (such as a coil element 10 to be described later) into a slot (such as a slot 16 to be described later) of a stator core (such as a stator core 15 to be described later) in which a partially protruding insulation paper (such as an insulation paper 17 to be described later) is disposed, the insertion device including the following: a guide part (such as a guide part 3 to be described later) that guides a leg part (such as a leg part 10a to be described later) of the electric conductor into the slot; a pair of expanding plates (such as a pair of expanding plates 7A, 7B to be described later) that extend in an insertion direction from a distal end of the guide part, and that are capable of expanding at the distal end side, the expanding plates extending obliquely with respect to the insertion direction so as to become close to each other toward the distal end side and being formed such that the gap therebetween is narrower than the width of the insulation paper on the distal end side and wider than the width of the leg part of the electric conductor on the proximal end side; a relative movement part (such as a relative movement part 35 to be described later) that relatively moves at least one of the guide part and the stator core in the axial direction so that distal ends (such as distal ends 71 to be described later) of the expanding plates are disposed on the inside of a protruding part of the insulation paper; a pressing part (such as a pressing part 80 to be described later) that is arranged so that a distal end thereof is disposed more toward the stator core side than the distal ends of the expanding plates in the axial direction, and that presses a top surface of the stator core downwards in the axial direction; and an insertion movement part (such as an insertion movement part 4 to be described later) that inserts the leg part of the electric conductor which is guided by the guide part into a space between the expanding plates, and that presses the leg part in the insertion direction to insert the leg part into the slot where the insulation paper is disposed.

When the leg part of the electric conductor is inserted into the slot of the stator core, it is desirable to arrange the distal ends of the expanding plates within the width of the insulation paper protruding from the stator core. However, the stator core has a structure in which thin steel plates are stacked, and thus the height thereof is not uniform because air enters the gap between the steel plates. In addition, the lack of uniformity in terms of height is witnessed in comparison between a plurality of places in a circumferential direction as well as comparison between the stator cores. Accordingly, even if the expanding plates are arranged at predetermined positions, the height variations of the stator core lead to a problem such as the impossibility of pulling out the expanding plates after a movement of the distal end into the slot and insertion of the electric conductor. In contrast, according to the present invention, the height of the stator core can be uniform as the top surface of the stator core is pressed downwards by the pressing part. In addition, since the expanding plates are arranged in a state where the height of the stator core is uniform, the expanding plates are arranged in intended places at all times, and thus the insertability of the electric conductor can be improved. Therefore, according to the present invention, it is possible to provide the electric conductor insertion device with which the impact of variations in axial direction length of the stator core can be suppressed.

Preferably, the pressing part is provided directly or indirectly at the guide part.

In the present invention, the pressing part is provided directly or indirectly at the guide part. As a result, the top surface of the stator core can be pressed and the expanding plates can be arranged inside the insulation paper at the same time even without a separate mechanism for moving the pressing part in the axial direction, and thus the device itself can be reduced in size. In addition, the electric conductor is stable in terms of insertability as the positional relationship between the expanding plates and the distal end of the pressing part (top surface of the stator core) is always the same.

The present invention also provides an electric conductor insertion method for inserting an electric conductor into a slot of a stator core in which a partially protruding insulation paper is disposed, the electric conductor insertion method including the following: a relative movement process in which a relative movement part relatively moves at least one of a guide part and the stator core in the axial direction so that distal ends of a pair of expanding plates are disposed on the inside of a protruding part of the insulation paper, the expanding plates extending in an insertion direction from a distal end of the guide part, being capable of expanding at the distal end side, extending obliquely with respect to the insertion direction so as to become close to each other toward the distal end side, and being formed such that the gap therebetween is narrower than the width of the insulation paper on the distal end side and wider than the width of the leg part of the electric conductor on the proximal end side; a pressing process in which a pressing part presses a top surface of the stator core downwards in the axial direction, the pressing part being arranged so that a distal end thereof is disposed more toward the stator core side than the distal ends of the expanding plates in the axial direction; a guide process in which the guide part guides the leg part of the electric conductor to the slot; and an insertion movement process in which an insertion movement part inserts the leg part of the electric conductor which is guided by the guide part into a space between the expanding plates and presses the leg part in the insertion direction to insert the leg part into the slot where the insulation paper is disposed.

By the insertion method according to the present invention, the height of the stator core can be uniform as the top surface of the stator core is pressed downwards by the pressing part as in the case of the invention for the insertion device described above. In addition, since the expanding plates are arranged in a state where the height of the stator core is uniform, the expanding plates are arranged in intended places at all times, and thus the insertability of the electric conductor can be improved. Therefore, according to the present invention, it is possible to provide an electric conductor insertion method by which the impact of variations in axial direction length of the stator core can be suppressed.

Preferably, the pressing part is provided directly or indirectly at the guide part and the pressing part presses the top surface of the stator core and the distal ends of the expanding plates are disposed on the inside of the protruding part of the insulation paper by the relative movement part relatively moving at least one of the guide part and the stator core in the axial direction in the relative movement process.

By the insertion method according to the present invention, the top surface of the stator core can be pressed and the expanding plates can be arranged inside the insulation paper at the same time, as in the case of the invention for the insertion device described above, even without a separate mechanism for moving the pressing part in the axial direction. In addition, the electric conductor is stable in terms of insertability as the positional relationship between the expanding plates and the distal end of the pressing part (top surface of the stator core) is always the same.

### Effects of the Invention

According to the present invention, it is possible to provide an electric conductor insertion device and insertion method with which the impact of variations in axial direction length of a stator core can be suppressed.

### BRIEF DESCRIPTION OF THE DRAWINGS

FIG. 1 is a plan view of an insertion device according to an embodiment of the present invention, illustrating a state where guide parts have advanced radially inwards and gathered.

FIG. 2 is a perspective view of the insertion device according to the embodiment, illustrating a state where the guide parts have retreated radially outwards and dispersed.

FIG. 3 is a side view of the insertion device according to the embodiment.

FIG. 4 is a perspective view in which the insertion device according to the embodiment is seen from the radially inner side.

FIG. 5 is a perspective view in which the bottom surface side of the insertion device according to the embodiment is seen from the radially outer side.

FIG. 6 is an enlarged view in which the guide part and a pair of expanding plates according to the embodiment are seen from the radially inner side.

FIG. 7 is a sectional view taken along line A-A of FIG. 4.

FIG. 8 is a perspective view illustrating a state where a coil element is inserted into a slot of a stator core by the insertion device according to the embodiment.

FIG. 9 is a sectional view corresponding to the A-A sectional view in FIG. 8.

FIG. 10 is a diagram for describing the operation of a pressing part and the expanding plate at a time when the guide part is moved, in which FIG. 10(a) illustrates a state where a divided guide part is moved in the radial direction, FIG. 10(b) illustrates a state where the divided guide part is moved in an axial direction and the pressing part abuts against a top surface of the stator core, and FIG. 10(c) illustrates a state where the divided guide part is further moved in the axial direction and the pressing part presses the top surface of the stator core axially downwards.

FIG. 11 is a diagram for describing an operation of the expanding plates, in which FIG. 11(a) illustrates how the guide part guides a leg part of the coil element between the expanding plates, FIG. 11(b) illustrates how the leg part of the coil element is inserted between the expanding plates, and FIG. 11(c) illustrates how distal end sides of the expanding plates are expanded by the insertion of the leg part of the coil element.

FIG. 12 is a diagram for describing the operation of the expanding plates, in which FIG. 12(a) is a plan view of the slot, FIG. 12(b) is a plan view illustrating a state where the insertion device is arranged on the slot, and FIG. 12(c) is a plan view illustrating a state where the leg part of the coil element is inserted in the slot.

### PREFERRED MODE FOR CARRYING OUT THE INVENTION

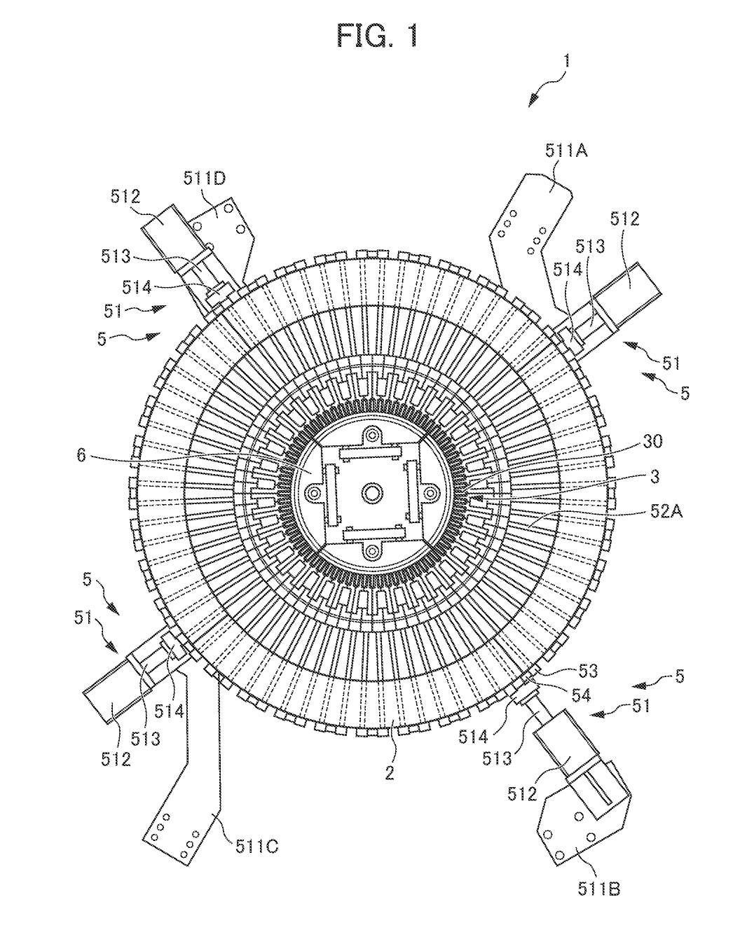

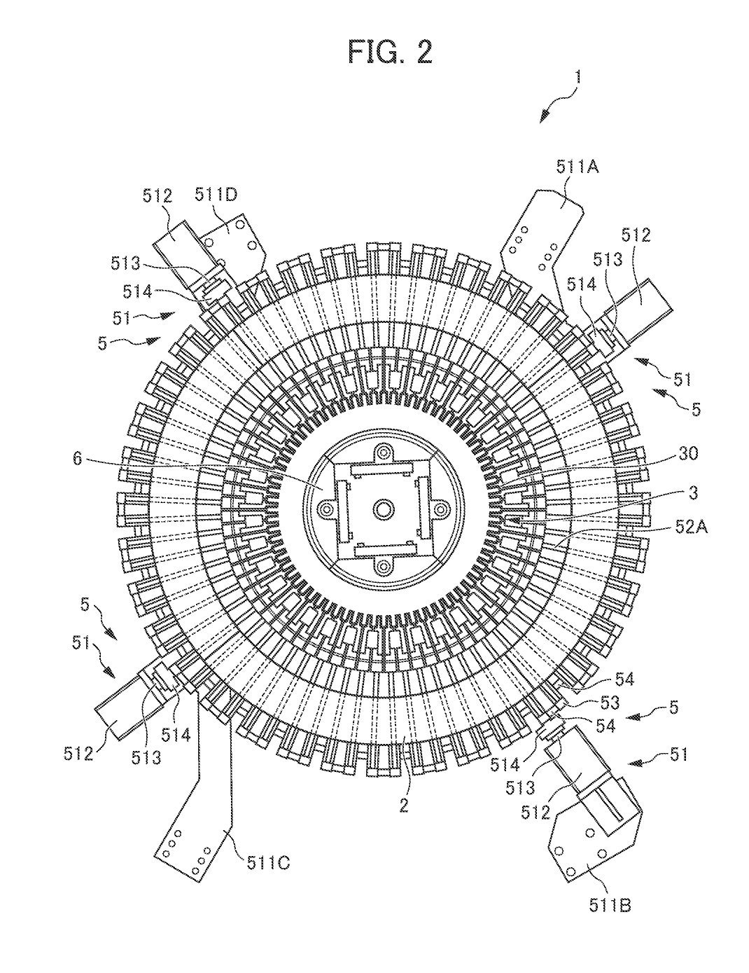

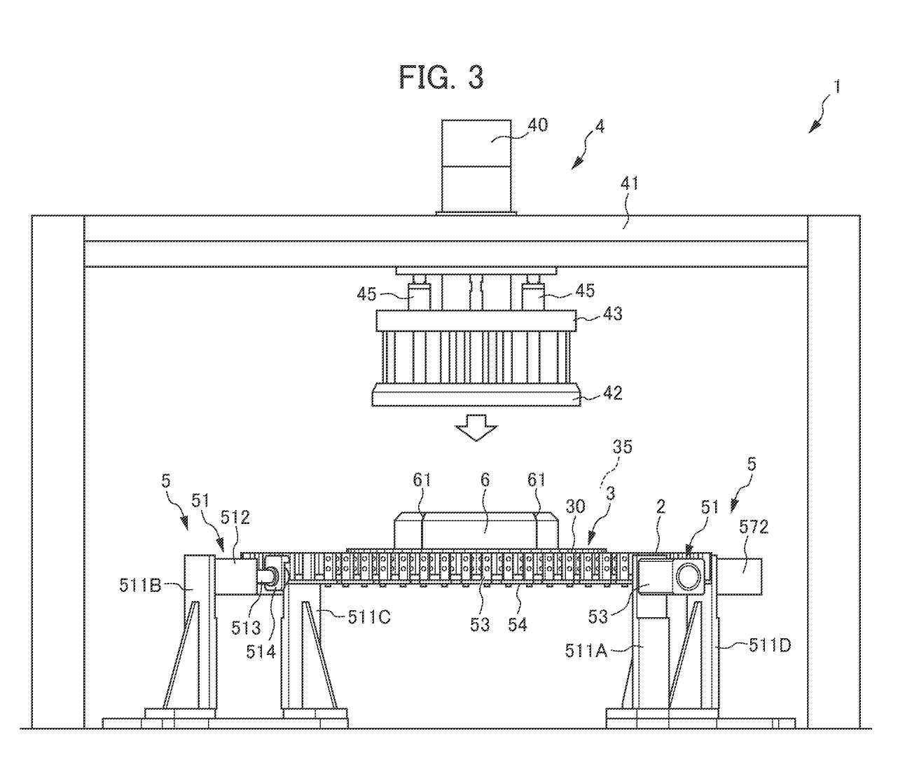

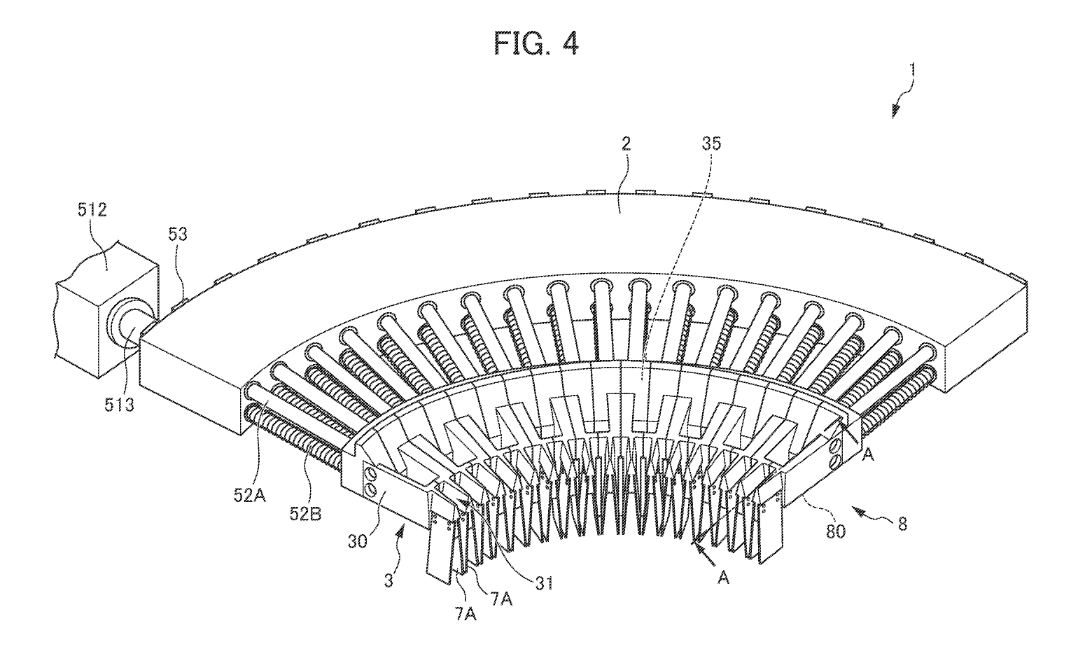

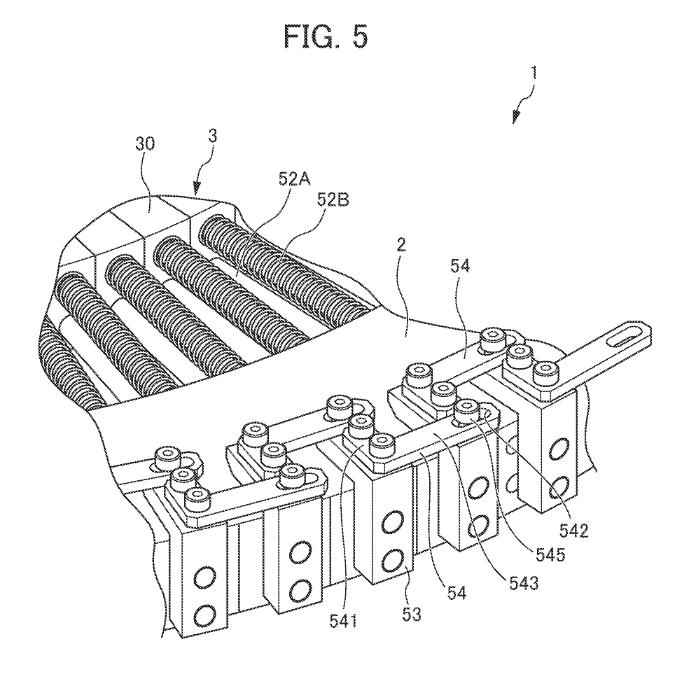

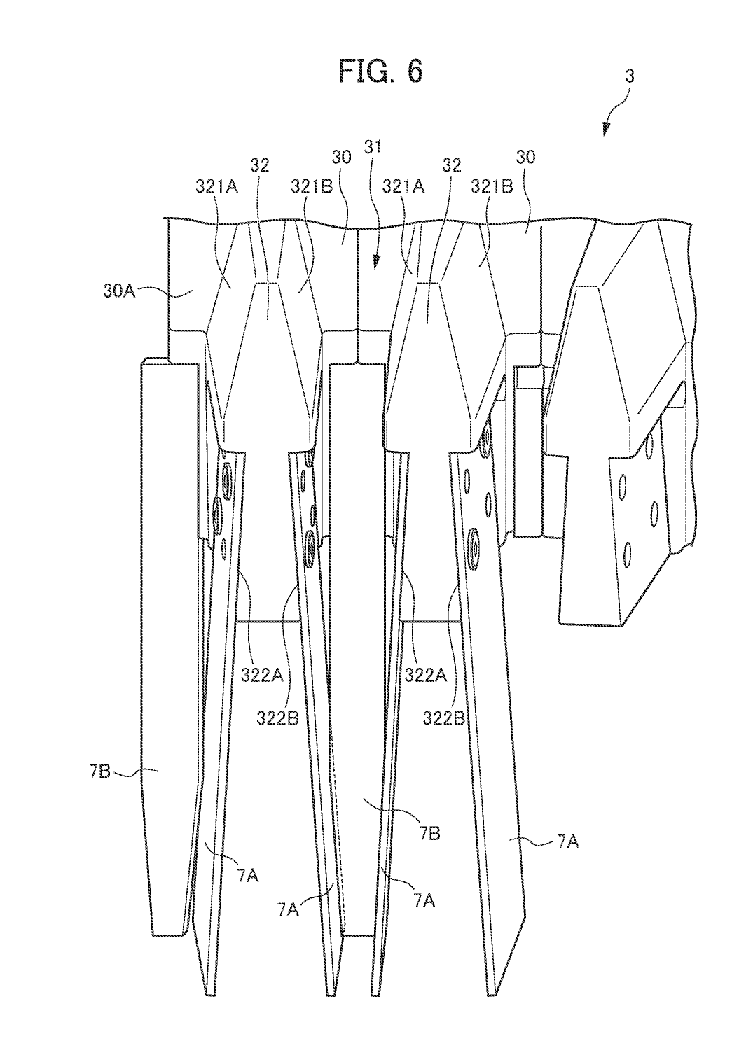

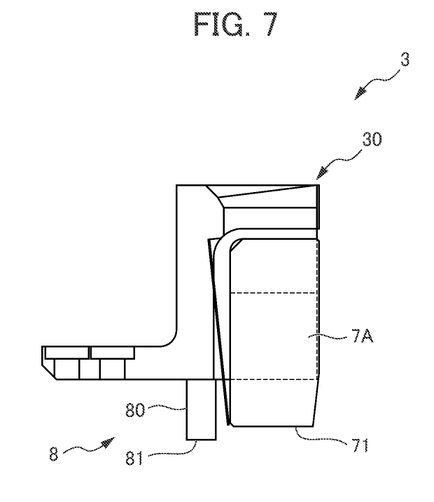

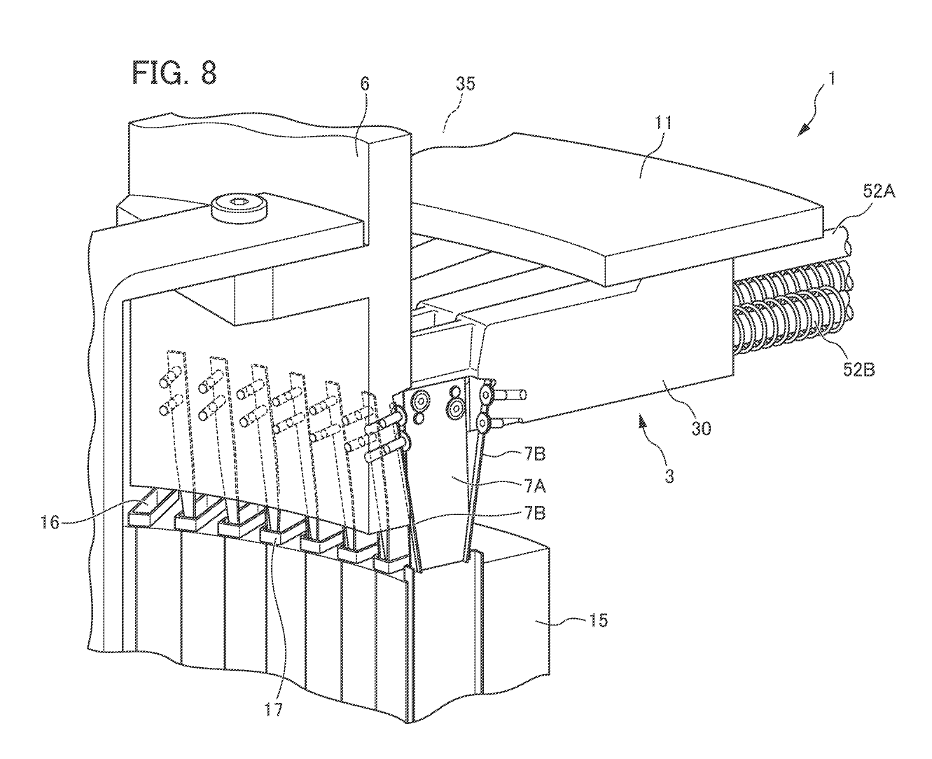

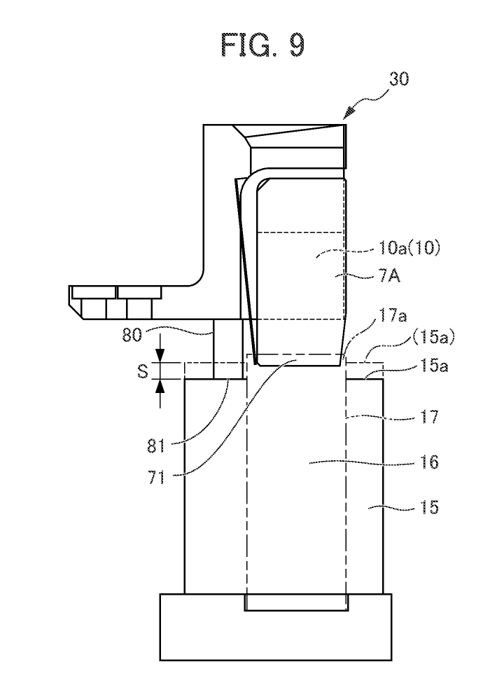

Hereinafter, a first embodiment of the present invention will be described in detail with reference to accompanying drawings. An insertion device 1 according to the embodiment will be described first with reference to FIGS. 1 to 9. FIG. 1 is a plan view of an insertion device according to an embodiment of the present invention, illustrating a state where guide parts have advanced radially inwards and gathered. FIG. 2 is a perspective view of the insertion device according to the embodiment, illustrating a state where the guide parts have retreated radially outwards and dispersed. FIG. 3 is a side view of the insertion device according to the embodiment. FIG. 4 is a perspective view in which the insertion device according to the embodiment is seen from the radially inner side. FIG. 5 is a perspective view in which the bottom surface side of the insertion device according to the embodiment is seen from the radially outer side. FIG. 6 is an enlarged view in which the guide part and a pair of expanding plates according to the embodiment are seen from the radially inner side. FIG. 7 is a sectional view taken along line A-A of FIG. 4. FIG. 8 is a perspective view illustrating a state where a coil element is inserted into a slot of a stator core by the insertion device according to the embodiment. FIG. 9 is a sectional view corresponding to the A-A sectional view in FIG. 8. An insertion movement part to be described later is omitted in FIGS. 1 and 2 for convenience.

As illustrated in FIGS. 1 to 9, the insertion device 1 (electric conductor insertion device) is provided with a base 2, an inner peripheral guide 6, a guide part 3, a guide movement part 5, a relative movement part 35, and an insertion movement part 4. In addition, the insertion device 1 has a pressing part 80 and a pair of expanding plates 7A, 7A and a pair of expanding plates 7B, 7B attached to the guide part 3 (divided guide part 30 to be described later). The insertion device 1 according to the present embodiment is an insertion device which inserts a plurality of substantially U-shaped coil elements 10 (electric conductors) for a rotary electric machine into a slot 16 of a stator core 15 in which a partially protruding insulation paper 17 is disposed.

In the present embodiment, the stator core 15 is formed by thin steel plates being stacked and arranged. The stator core 15 is formed in an annular shape when viewed from an axial direction. The stator core 15 has a plurality of the slots 16 having spaces extending in the axial direction and formed at predetermined intervals in a circumferential direction.

In the present embodiment, each of the slots 16 is formed to have a rectangular parallelepiped space. The slots 16 have a rectangular cross section. The insulation paper 17 is inserted and arranged in each of the slots 16.

The insulation paper 17 is arranged so as to cover the inside surface (all sides) of the slot 16. The insulation paper 17 has an end part (protruding part 17a) arranged to protrude from a top surface 15a of the stator core. The protruding part 17a that is an end part is a part where distal ends 71 (described later) of the expanding plates 7A, 7A and the expanding plates 7B, 7B to be described later are inserted and arranged and a part expanding to the expanding plates 7A, 7A and the expanding plates 7B, 7B.

In the present embodiment, the stator core 15 is placed on a pallet 90. A recessed portion 91 continuous with each slot 16 is formed at a position in the pallet 90 where each slot 16 is arranged. The lower end of the insulation paper 17 and a leg part 10a of the coil element 10 are placed in the recessed portion 91. The axial position of the end part (protruding part 17a) of the insulation paper 17 arranged in each slot 16 is aligned by the lower end of the insulation paper 17 being positioned by the recessed portion 91.

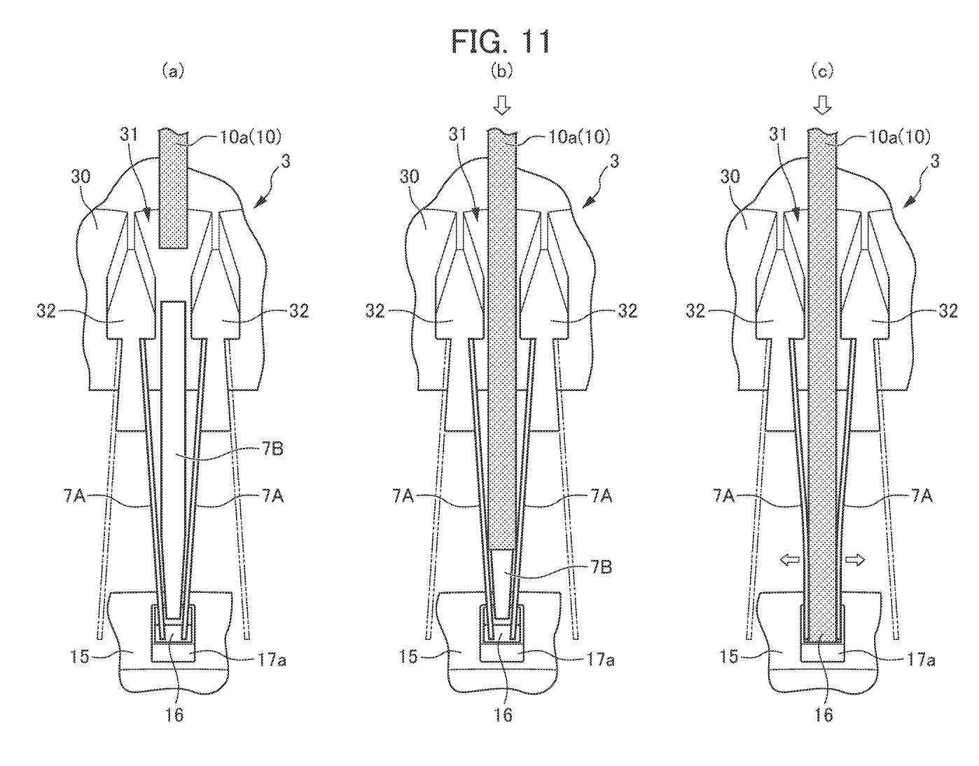

As illustrated in FIGS. 1 to 5, an annular flat plate constitutes the base 2 and the base 2 supports a slide mechanism 20 that supports the guide part 3, which will be described later. In the insertion device 1 according to the present embodiment, the stator core 15 (see FIG. 8) of a rotary electric machine (described later) is arranged below the central part of the base 2. Arranged on the upper side of the base 2 is an alignment device (not illustrated) aligning the substantially U-shaped coil elements 10 (see FIG. 11) in an annular shape while overlapping the coil elements 10 in the circumferential direction.

As illustrated in FIGS. 1 to 3, the inner peripheral guide 6 is arranged at the central part of the base 2. The annularly aligned coil elements 10 are arranged on the outer periphery of the inner peripheral guide 6. As a result, the leg parts 10a (see FIG. 11) of the coil elements 10 annularly aligned by the alignment device can be inserted into the respective slots 16 (see FIG. 8) of the stator core 15 by the insertion device 1 according to the present embodiment.

As illustrated in FIGS. 1 to 9, the guide part 3 guides the leg part 10a of the coil element 10 to the slot 16. The guide part 3 guides the leg part 10a of the coil element 10 inserted and moved by the insertion movement part 4 to the slot 16 of the stator core 15. As illustrated in FIG. 4, the guide part 3 is provided in an annular shape. The guide part 3 is configured to have the divided guide part 30 divided into a plurality of units in the circumferential direction.

The divided guide part 30 has a tapered structure 31 arranged on a distal end side (radially inner side) and expanding in the direction that is opposite to an insertion direction (to the stator core 15 side, for example, downward in FIG. 4). The tapered structure 31 of the guide part 3 is formed by a protruding part 32 being adjacent that has an arrow-shaped cross section and protrudes from a distal end surface 30A of the divided guide part 30. More specifically, upper side surfaces 321A, 321B of the protruding part 32 are oblique so as to be separated from each other downwards, and the tapered structure 31 is formed by the upper side surfaces 321A, 321B of the protruding parts 32, 32 that are adjacent to each other.

Provided for each tapered structure 31 below the tapered structure 31 of each divided guide part 30 are a pair of first expanding plates 7A, 7A (pair of expanding plates) and a pair of second expanding plates 7B, 7B (pair of expanding plates). The second expanding plate 7B is omitted in each of the drawings for convenience.

The first expanding plates 7A, 7A are provided corresponding to the long side of the slot 16 having a rectangular cross section. The second expanding plates 7B, 7B are provided corresponding to the short side of the slot 16.

The first expanding plates 7A, 7A and the second expanding plates 7B, 7B are pairs of expanding plates that extend in the insertion direction (to the stator core 15 side) from the distal end of the divided guide part 30 (guide part 3) and have an expandable distal end side. The first expanding plates 7A, 7A and the second expanding plates 7B, 7B extend obliquely with respect to the insertion direction so as to become close to each other toward the distal end side. The first expanding plates 7A, 7A and the second expanding plates 7B, 7B are formed such that the gap therebetween is narrower than the width of the insulation paper 17 on the distal end side and wider than the width of the leg part 10a of the coil element 10 on the proximal end side.

Specifically, the first expanding plates 7A, 7A and the second expanding plates 7B, 7B extend in the insertion direction from the distal end of the guide part 3. Here, lower side surfaces 322A, 322B of the protruding part 32 are oblique so as to be separated from each other downwards, and thus a tapered structure expanding in the direction that is opposite to the insertion direction is formed also at the lower part of the protruding part by the lower side surfaces 322A, 322B of the protruding parts 32, 32 that are adjacent to each other.

The first expanding plates 7A, 7A are connected to the lower side surfaces 322A, 322B of the protruding part 32 and extend downwards along the lower side surfaces 322A, 322B. In other words, the first expanding plates 7A, 7A extend obliquely with respect to the insertion direction so as to become close to each other toward the distal end side.

Likewise, the second expanding plates 7B, 7B extend obliquely with respect to the insertion direction so as to become close to each other toward the distal end side. The second expanding plate on the back side is connected to the inclined surface (surface inclined radially inwards and downwards) formed at the lower part of the distal end surface of the guide part 3, and the second expanding plate on the near side is connected to the inclined surface (surface inclined radially inwards and downwards) formed on the outer periphery of the inner peripheral guide 6 as illustrated in FIG. 7 (described later).

In addition, each of the expanding plates is formed such that the distal end side can expand as a result of bending. The gap between the expanding plates is narrower than the width of the insulation paper (distance between the insulation papers that face each other) on the distal end side and wider than the width of the leg part 10a of the coil element 10 (including the width and the thickness) on the proximal end side.

As illustrated in FIGS. 4, 7, and 9, the pressing part 80 presses the top surface 15a of the stator core 15 axially downwards with a pressing surface 81 (distal end) arranged closer to the stator core 15 side than the distal ends 71 of the expanding plates 7A, 7A and the expanding plates 7B, 7B in the axial direction. In the present embodiment, the pressing part 80 is attached directly or indirectly to the guide part 3 (divided guide part 30). In the present embodiment, the pressing part 80 integrally moves with an axial movement of the divided guide part 30 (guide part 3), and the pressing part 80 presses the top surface 15a of the stator core 15 by moving to the lower side in the axial direction (in the insertion direction) while abutting against the top surface 15a of the stator core 15 by means of the pressing surface 81. The pressing part 80 eliminates height (thickness) variations attributable to, for example, the space generated between the steel plates stacked in the stator core 15 by pressing the top surface 15a of the stator core 15 axially downwards. For example, as illustrated in FIG. 9, the pressing part 80 eliminates the height (thickness) variations by pushing down the top surface 15a of the stator core 15 by a distance S and moving the top surface 15a to a prescribed position.

The pressing part 80 is fixed to the divided guide part 30 (guide part 3) at a position where the distance between the pressing surface 81 and the distal ends 71 of the expanding plates 7A, 7A and the expanding plates 7B, 7B is constant. As a result, the pressing part 80 moves the top surface 15a of the stator core 15 to a prescribed position and arranges the distal end 71 of the expanding plate at a position at a predetermined distance (constant distance) from the moved top surface 15a. The pressing part 80 positions the distal end 71 of the expanding plate inside the protruding part 17a of the insulation paper 17.

As illustrated in FIGS. 1 to 5, the guide movement part 5 radially moves each of the divided guide parts 30 constituting the guide part 3 and divided in the circumferential direction. The guide movement part 5 is provided with four second cylinder mechanisms 51, a slide pin 52A and a spring-attached slide pin 52B provided for each divided guide part 30, a connecting part 53 connecting the proximal ends (radially outside ends) of the slide pins, and a link mechanism 54 disposed on the bottom surface side of the connecting part 53 and joining the connecting parts 53 that are adjacent to each other.

The four second cylinder mechanisms 51 are arranged at equal intervals in the circumferential direction. The second cylinder mechanism 51 is provided with a second support base 511 (511A to 511D), a cylindrical cylinder 512 supported by the second support base 511, a piston (not illustrated) provided so as to be capable of reciprocating in the cylinder 512, a rod 513 connected to the piston, and a connecting part 514 provided at the distal end of the rod 513 and connected to the connecting part 53. The driving force of the second cylinder mechanism 51 is transmitted to each slide pin via the connecting part 514, the connecting part 53, and the link mechanism 54.

The slide pin 52A and the spring-attached slide pin 52B are provided for each divided guide part 30 and have distal ends connected to the divided guide part 30. The slide pin 52A is disposed on the upper side and the spring-attached slide pin 52B is disposed on the lower side. Each of the slide pins radially penetrates the base 2 and the proximal ends (radially outside ends) of the slide pins are interconnected by the connecting part 53. The slide pins radially move each divided guide part 30 by receiving the driving force of the second cylinder mechanism 51 and sliding in the radial direction.

More specifically, when the driving force of the second cylinder mechanism 51 is not received, each of the slide pins is slid radially inwards by the biasing force of the spring of the spring-attached slide pin 52B. As a result, each divided guide part 30 advances radially inwards and gathers. When the driving force of the second cylinder mechanism 51 is received, each of the slide pins slides radially outwards against the biasing force of the spring. As a result, each divided guide part 30 retreats radially outwards and disperses. The spring is unnecessary when the second cylinder mechanism 51 is changed to a cylinder capable of performing a reciprocating motion.

The connecting part 53 interconnects the proximal ends (radially outside ends) of the slide pins, and the connecting parts 53 that are adjacent to each other are joined to each other by the L-shaped link mechanism 54 on the bottom surface sides thereof. As illustrated in FIG. 5, an L-shaped member that has a plate shape and a bolt 545 constitute the link mechanism 54, and the plate-shaped member has a longitudinal part 543 where a short part 541 and a long hole 542 are formed. In this link mechanism 54, the short part 541 is fixed to the bottom surface of one connecting part 53. The long hole 542 formed in the longitudinal part 543 is formed to have a width smaller than the diameter of the head part of the bolt 545 and slightly larger than the diameter of the shaft part of the bolt 545. The bolt 545 is fixed to the bottom surface of another connecting part 53 in a state where the shaft part of the bolt 545 is inserted in the long hole 542 and a gap is ensured between the longitudinal part 543 and the head part of the bolt 545. As a result, a width-direction movement of the bolt 545 in the long hole 542 is regulated and a length-direction movement of the bolt 545 in the long hole 542 is allowed. Accordingly, the connecting part 53 moves in the radial direction by following a radial movement of the adjacent connecting part 53.

The relative movement part 35 relatively moves the guide part 3 and/or the stator core 15 in the axial direction such that the distal ends 71 of the expanding plates are arranged inside the protruding part 17a of the insulation paper 17. In the present embodiment, the relative movement part 35 axially moves the guide part 3. In the present embodiment, the relative movement part 35 moves the pressing part 80 in the axial direction (insertion direction) via the guide part 3 (divided guide part 30). By moving the guide part 3, the relative movement part 35 presses the top surface 15a of the stator core 15 by means of the pressing part 80 and positions the distal end 71 of the expanding plate inside the protruding part 17a of the insulation paper 17.

As illustrated in FIG. 3, the insertion movement part 4 inserts the leg part 10a of the coil element 10 guided by the guide part 3 (divided guide part 30) between the expanding plates 7A, 7A (and between the expanding plates 7B, 7B) and inserts the leg part 10a into the slot 16 where the insulation paper 17 is disposed by pressing in the insertion direction. The insertion movement part 4 is provided with a first support base 41, an actuator 40 supported by the first support base 41, an annular body 42, a circular body 43, and first cylinder mechanisms 45, 45 lifting and lowering the annular body 42 and the circular body 43.

The annular body 42 is an annular body slightly larger in diameter than the inner peripheral guide 6 arranged below. Once the annular body 42 and the circular body 43 are lowered by the first cylinder mechanisms 45, 45 being driven by the actuator 40, the annular body 42 is fitted first to the outer periphery of the inner peripheral guide 6 to descend by sliding on the outer periphery. At this time, since the outer periphery of the inner peripheral guide 6 is provided with a plurality of slits 61 extending in a central axis direction, the inner peripheral guide 6 slightly contracts radially inwards as a result of the fitting of the annular body 42.

Also at this time, the annular body 42 abuts against the upper parts of the coil elements (not illustrated) annularly aligned on the outer periphery of the inner peripheral guide 6 and presses the coil elements downwards. As a result, the leg parts 10a of the annularly aligned coil elements 10 are guided by the insertion device 1 according to the present embodiment and are inserted into the slot 16 of the stator core 15 (not illustrated) arranged below.

In addition, the circular body 43 descends similarly to the annular body 42 to eventually abut against the upper part of the inner peripheral guide 6. As a result, lowering of the annular body 42 is regulated and a more-than-necessary downward movement of the coil element is prevented.

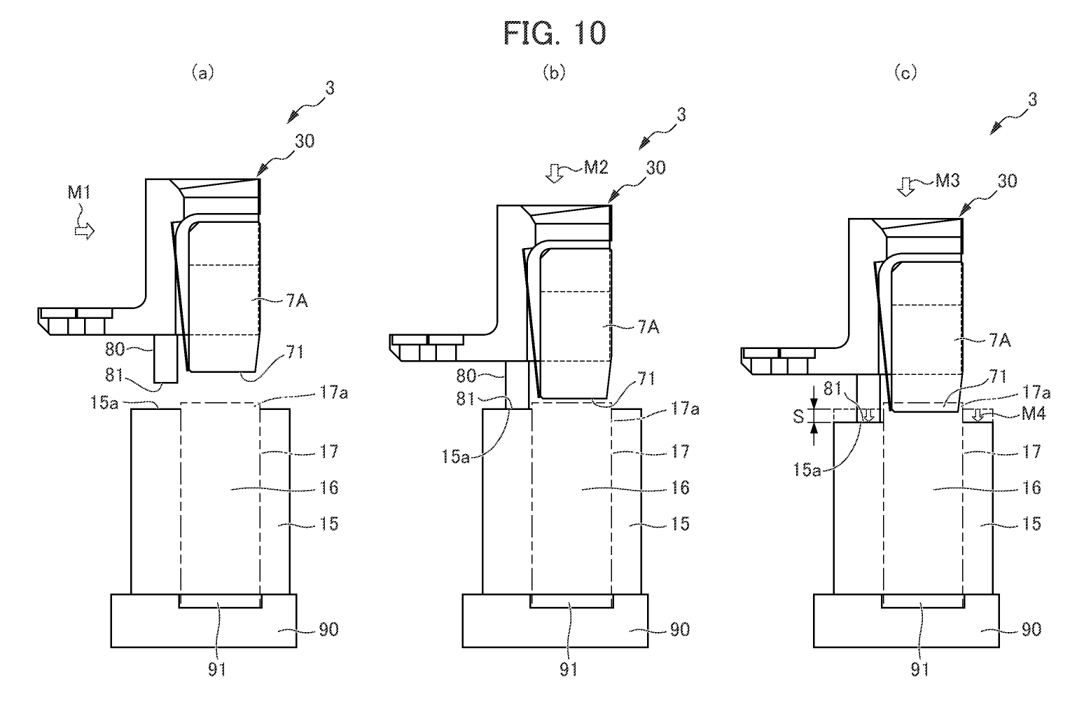

An operation of the insertion device 1 will be described below with reference to FIGS. 10 to 12. Described below is an electric conductor insertion method for inserting, by means of the insertion device 1, the coil element 10 into the slot 16 of the stator core 15 in which the partially protruding insulation paper 17 is disposed.

Described first with reference to FIG. 10 is an operation in which the distal end 71 of the expanding plate is moved to the inside of the protruding part 17a of the insulation paper 17 in the insertion device 1. FIG. 10 is a diagram for describing the operation of the pressing part and the expanding plate at a time when the guide part is moved, in which FIG. 10(a) illustrates a state where the divided guide part is moved in the radial direction, FIG. 10(b) illustrates a state where the divided guide part is moved in the axial direction and the pressing part abuts against the top surface of the stator core, and FIG. 10(c) illustrates a state where the divided guide part is further moved in the axial direction and the pressing part presses the top surface of the stator core axially downwards.

As illustrated in FIG. 10(a), the guide movement part 5 moves the divided guide part 30 (guide part 3) in an arrow M1 direction, which is the radial direction. The guide movement part 5 slides each slide pin radially inwards by using the biasing force of the spring-attached slide pin 52B without driving the second cylinder mechanism 51. As a result, the guide movement part 5 causes each divided guide part 30 to advance radially inwards and gather. The guide movement part 5 arranges the expanding plates 7A, 7A (and 7B, 7B) above the slot 16 by moving the divided guide part 30 in the arrow M1 direction.

Subsequently, as illustrated in FIG. 10(b), the relative movement part 35 moves the divided guide part 30 in an arrow M2 direction, which is the insertion direction. The relative movement part 35 moves the pressing part 80 in the insertion direction via the divided guide part 30. As a result, the pressing surface 81 of the pressing part 80 abuts against the top surface 15a of the stator core 15.

Subsequently, as illustrated in FIG. 10(c), the relative movement part 35 further moves the divided guide part 30 in an arrow M3 direction, which is the insertion direction. The relative movement part 35 further moves the pressing part 80 in the insertion direction via the divided guide part 30. As a result, the pressing part 80 presses the top surface 15a of the stator core 15 and pushes down the top surface 15a in the insertion direction (axially downwards). The pressing part 80 presses the top surface 15a of the stator core 15 axially downwards with the pressing surface 81 (distal end) arranged closer to the stator core 15 side than the distal ends 71 of the expanding plates in the axial direction by the divided guide part 30 being moved by the relative movement part 35 (pressing process). As a result, the top surface 15a of the stator core 15 is moved axially downwards by the distance S, and the thickness (axial direction length) variations of the stator core 15 attributable to, for example, the space part formed between the steel plates constituting the stator core 15 are eliminated.

In addition, the relative movement part 35 moves the expanding plate via the divided guide part 30 (guide part 3). The relative movement part 35 moves the expanding plate such that the distal end 71 of the expanding plate is positioned inside the protruding part 17a of the insulation paper 17 (relative movement process). In the present embodiment, the pressing part 80 is attached directly (or indirectly) to the divided guide part 30 (guide part 3), and the pressing part 80 presses the top surface 15a of the stator core 15 and the distal ends 71 of the expanding plates are arranged inside the protruding part 17a of the insulation paper 17 by the relative movement part 35 (relatively) moving the divided guide part 30 (guide part 3) in the axial direction. As a result, the distance between the distal end 71 of the expanding plate and the top surface 15a of the stator core 15 pushed down to a prescribed position by the pressing part 80 becomes constant. In addition, as a result, the distal end 71 of the expanding plate is positioned inside the protruding part 17a of the insulation paper 17 protruding axially upwards from the top surface 15a of the stator core 15.

Described below with reference to FIG. 11 is an operation of the insertion device 1 for inserting the leg part 10a of the coil element 10 into the slot 16. FIG. 11 is a diagram for describing an operation of the expanding plates, in which FIG. 11(a) illustrates how the guide part guides the leg part of the coil element between the expanding plates, FIG. 11(b) illustrates how the leg part of the coil element is inserted between the expanding plates, and FIG. 11(c) illustrates how the distal end sides of the expanding plates are expanded by the insertion of the leg part of the coil element.

First, the coil elements are annularly aligned and arranged, by an alignment device 11, on the outer periphery of the inner peripheral guide 6 arranged at the central part of the base 2. Although the coil elements 10 are not illustrated in FIG. 11, the coil elements 10 are annularly aligned by the alignment device 11 arranged above the insertion device 1.

Subsequently, the annular body 42 and the circular body 43 are lowered by the first cylinder mechanisms 45, 45 being driven by the actuator 40. Then, the annular body 42 is fitted to the outer periphery of the inner peripheral guide 6 and descends by sliding on the outer periphery, and the inner peripheral guide 6 having the slit 61 slightly contracts radially inwards. Also at this time, the annular body 42 abuts against the upper parts of the coil elements annularly aligned on the outer periphery of the inner peripheral guide 6 and presses the coil elements downwards. As a result, the leg parts of the annularly aligned coil elements are guided by the guide part 3 of the insertion device 1.

Specifically, as illustrated in FIG. 11(a), the guide part 3 guides the leg part 10a of the coil element 10 to the slot 16 (guide process). The guide part 3 guides, to the slot 16, the leg part 10a of the coil element 10 inserted between the expanding plates 7A, 7A and the expanding plates 7B, 7B. The guide part 3 has the tapered structure 31 expanding in the direction opposite to the insertion direction, and thus the leg part of the coil element 10 is reliably guided between the first expanding plates 7A, 7A and between the second expanding plates 7B, 7B even if the position of the leg part of the coil element 10 and the position of the guide part 3 are somewhat misaligned.

Subsequently, as illustrated in FIG. 11(b), the leg part of the coil element 10 is inserted between the first expanding plates 7A, 7A and between the second expanding plates 7B, 7B.

Subsequently, as illustrated in FIG. 11(c), the distal end sides of the first expanding plates 7A, 7A and the second expanding plates 7B, 7B expand once the leg part 10a of the coil element 10 is inserted up to the distal end of each expanding plate. As a result, the space between the end parts of the insulation paper 17 is expanded, and the leg part 10a of the coil element 10 is inserted into the slot 16.

As illustrated in FIGS. 11(b) and 11(c), the insertion movement part 4 inserts the leg part 10a of the coil element 10 guided by the guide part 3 between the first expanding plates 7A, 7A and between the second expanding plates 7B, 7B and inserts the leg part 10a into the slot 16 where the insulation paper 17 is disposed by pressing in the insertion direction (insertion movement process).

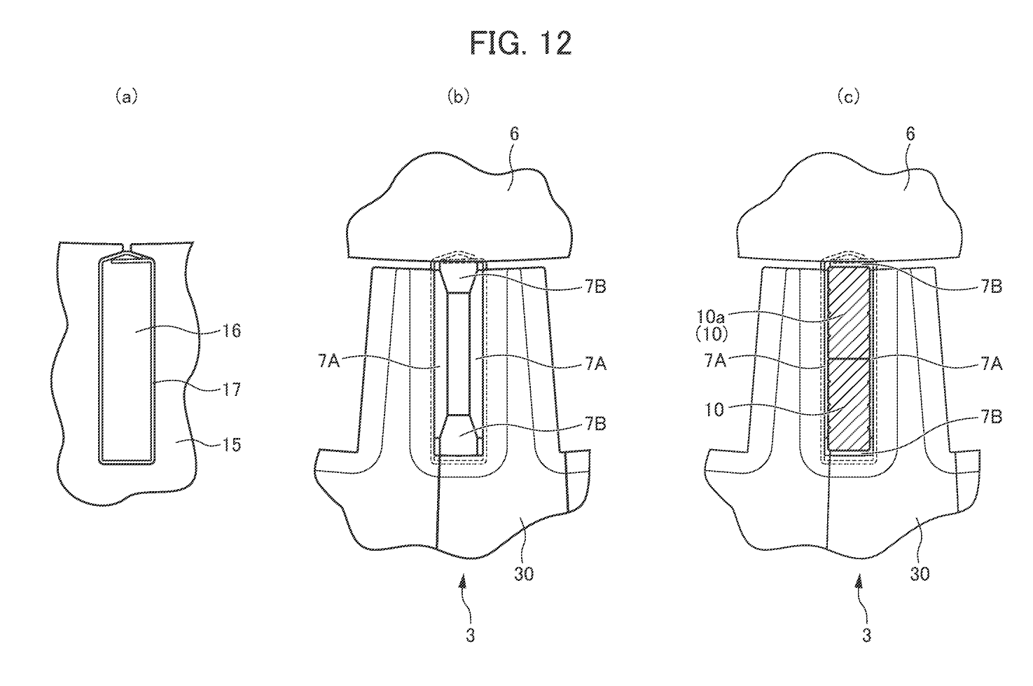

Hereinafter, the operation of the insertion device 1 for inserting the leg part 10a of the coil element 10 into the slot 16 will be described from another perspective with reference to FIG. 12. FIG. 12 is a diagram for describing the operation of the expanding plates, in which FIG. 12(a) is a plan view of the slot, FIG. 12(b) is a plan view illustrating a state where the insertion device is arranged on the slot, and FIG. 12(c) is a plan view illustrating a state where the leg part of the coil element is inserted in the slot.

As illustrated in FIG. 12(a), the guide part 3 is not arranged on the slot 16 in a state where the guide part 3 is yet to gather. Subsequently, once the guide part 3 gathers as illustrated in FIG. 12(b), the guide part 3 is arranged on the slot 16. Here, both the first expanding plates 7A, 7A and the second expanding plates 7B, 7B have a narrow distal end side gap. Subsequently, once the leg part 10a of the coil element 10 is guided by the guide part 3 and inserted between the first expanding plates 7A, 7A and between the second expanding plates 7B, 7B as illustrated in FIG. 12(c), the distal end sides of the expanding plates are expanded, and the protruding part 17a of the insulation paper 17 is expanded as a result. In this manner, the end part of the insulation paper 17 is expanded and the leg part 10a of the coil element 10 is reliably inserted into the slot 16.

The present embodiment has the following effects. When the leg part 10a of the coil element 10 is inserted into the slot 16 of the stator core 15, it is desirable to arrange the distal ends 71 of the expanding plates 7A, 7B within the width of the insulation paper 17 protruding from the stator core 15. However, the stator core 15 has a structure in which thin steel plates are stacked, and thus the height thereof is not uniform because air enters the gap between the steel plates. In addition, the lack of uniformity in terms of height is witnessed in comparison between a plurality of places in the circumferential direction as well as comparison between the stator cores 15. Accordingly, even if the expanding plates 7A, 7B are arranged at predetermined positions, the height variations of the stator core 15 lead to a problem such as the impossibility of pulling out the expanding plates 7A, 7B after a movement of the distal end 71 into the slot 16 and insertion of the leg part 10a of the coil element 10. In contrast, in the insertion device 1 according to the present embodiment, the height of the stator core 15 can be uniform as the top surface 15a of the stator core 15 is pressed downwards by the pressing part 80. In addition, since the expanding plates 7A, 7B are arranged in a state where the height of the stator core 15 is uniform, the expanding plates 7A, 7B are arranged in intended places at all times, and thus the insertability of the coil element 10 can be improved. Therefore, according to the present embodiment, it is possible to provide the electric conductor insertion device 1 with which the impact of variations in axial direction length of the stator core 15 can be suppressed.

In the insertion device 1 according to the present embodiment, the pressing part 80 is provided directly at the guide part 3. As a result, the top surface 15a of the stator core 15 can be pressed and the expanding plates 7A, 7B can be arranged inside the insulation paper 17 at the same time even without a separate mechanism for moving the pressing part 80 in the axial direction, and thus the device itself can be reduced in size. In addition, the coil element 10 is stable in terms of insertability as the positional relationship between the expanding plates 7A, 7B and the distal end of the pressing part 80 (top surface 15a of the stator core 15) is always the same. The insertion device 1 according to the present embodiment may be provided with a movement mechanism allowing the stator core 15 to approach the guide part 3 and a movement mechanism allowing the guide part 3 to approach the stator core 15.

By the insertion method according to the present embodiment, the height of the stator core 15 can be uniform as the top surface 15a of the stator core 15 is pressed downwards by the pressing part 80 as in the case of the insertion device 1 described above. In addition, since the expanding plates 7A, 7B are arranged in a state where the height of the stator core 15 is uniform, the expanding plates 7A, 7B are arranged in intended places at all times, and thus the insertability of the electric conductor can be improved. Therefore, by the insertion method according to the present embodiment, it is possible to provide an electric conductor insertion method by which the impact of variations in axial direction length of the stator core 15 can be suppressed.

By the insertion method according to the present embodiment, the top surface 15a of the stator core 15 can be pressed and the expanding plates 7A, 7B can be arranged inside the insulation paper 17 at the same time, as in the case of the insertion device 1 described above, even without a separate mechanism for moving the pressing part 80 in the axial direction. In addition, the electric conductor is stable in terms of insertability as the positional relationship between the expanding plates 7A, 7B and the distal end of the pressing part 80 (top surface 15a of the stator core 15) is always the same.

The present invention is not limited to the above-described embodiment, and modifications and improvements within a range that can achieve the object of the present invention are included in the present invention. For example, the electric conductor is not particularly limited insofar as it is an electric conductor although the substantially U-shaped coil element for a rotary electric machine is used as the electric conductor in the above-described embodiment. Although one projection-shaped pressing part is provided for one guide part in the above-described embodiment, the present invention is not limited thereto. For example, the pressing part may be shaped to be connected in the circumferential direction of the stator core and a plurality of the pressing parts may be provided in the circumferential direction of the stator core.

### EXPLANATION OF REFERENCE NUMERALS

1 INSERTION DEVICE
3 GUIDE PART
4 INSERTION MOVEMENT PART
5 GUIDE MOVEMENT PART
7A, 7B PAIR OF EXPANDING PLATES
10 COIL ELEMENT (ELECTRIC CONDUCTOR)
10a LEG PART
15 STATOR CORE
15a TOP SURFACE
16 SLOT
17 INSULATION PAPER
17a PROTRUDING PART
30 DIVIDED GUIDE PART
35 RELATIVE MOVEMENT PART
71 DISTAL END (DISTAL END OF EXPANDING PLATE)
80 PRESSING PART

1. An electric conductor insertion device which inserts an electric conductor into a slot of a stator core in which a partially protruding insulation paper is disposed, the insertion device comprising the following:
a guide part that guides a leg part of the electric conductor into the slot;
a pair of expanding plates that extend in an insertion direction from a distal end of the guide part, and that are capable of expanding at the distal end side, the expanding plates extending obliquely with respect to the insertion direction so as to become close to each other toward the distal end side and being formed such that the gap therebetween is narrower than the width of the insulation paper on the distal end side and wider than the width of the leg part of the electric conductor on the proximal end side;
a relative movement part that relatively moves at least one of the guide part and the stator core in the axial direction so that distal ends of the expanding plates are disposed on the inside of a protruding part of the insulation paper;
a pressing part that is arranged so that a distal end thereof is disposed more toward the stator core side than the distal ends of the expanding plates in the axial direction, and that presses a top surface of the stator core downwards in the axial direction; and
an insertion movement part that inserts the leg part of the electric conductor which is guided by the guide part into a space between the expanding plates, and that presses the leg part in the insertion direction to insert the leg part into the slot where the insulation paper is disposed.

2. The electric conductor insertion device according to claim 1, wherein the pressing part is provided directly or indirectly at the guide part.

3. An electric conductor insertion method for inserting an electric conductor into a slot of a stator core in which a partially protruding insulation paper is disposed, the electric conductor insertion method comprising the following:
a relative movement process in which a relative movement part relatively moves at least one of a guide part and the stator core in the axial direction so that distal ends of a pair of expanding plates are disposed on the inside of a protruding part of the insulation paper, the expanding plates extending in an insertion direction from a distal end of the guide part, being capable of expanding at the distal end side, extending obliquely with respect to the insertion direction so as to become close to each other toward the distal end side, and being formed such that the gap therebetween is narrower than the width of the insulation paper on the distal end side and wider than the width of the leg part of the electric conductor on the proximal end side;
a pressing process in which a pressing part presses a top surface of the stator core downwards in the axial direction, the pressing part being arranged so that a distal end thereof is disposed more toward the stator core side than the distal ends of the expanding plates in the axial direction;
a guide process in which the guide part guides the leg part of the electric conductor to the slot; and
an insertion movement process in which an insertion movement part inserts the leg part of the electric conductor which is guided by the guide part into a space between the expanding plates and presses the leg part in the insertion direction to insert the leg part into the slot where the insulation paper is disposed.

4. The electric conductor insertion method according to claim 3, wherein the pressing part is provided directly or indirectly at the guide part, and
the pressing part presses the top surface of the stator core and the distal ends of the expanding plates are disposed on the inside of the protruding part of the insulation paper by the relative movement part relatively moving at least one of the guide part and the stator core in the axial direction in the relative movement process.
